(19) United States
(12) Patent Application Publication
(10) Pub. No.: US 2016/0132427 A1
(43) Pub. Date: May 12, 2016

(54) USER INTERFACE CONFORMANCE

(71) Applicant: HEWLETT-PACKARD DEVELOPMENT COMPANY, L.P., Houston, TX (US)

(72) Inventors: Inbar Shani, Yehud (IL); Yaron Burg, Yehud (IL); Amichai Nitsan, Yehud (IL)

(21) Appl. No.: 14/898,504

(22) PCT Filed: Jun. 27, 2013
(86) PCT No.: PCT/US2013/048185

§ 371 Date: Dec. 15, 2015

(51) Int. Cl. G06F 11/36; G06F 3/048

(52) U.S. Cl. CPC G06F 11/3688; G06F 3/048; G06F 11/3664

(57) ABSTRACT

Verifying user interface conformance can include deriving a conformance rule set based on desired user interface characteristics identified through an examination of mockup data for the user interface. That mockup data includes a visual representation of the desired characteristics. Conformance data can then be generated based on differences between the desired characteristics and actual characteristics. Those differences are identified by processing the conformance rule set against screen capture data of the user interface as produced by an application under test. The screen capture data includes a visual representation of the actual characteristics of the user interface.

### BACKGROUND

User experience can be a key selling point for a software based product or service. Intuitive and visually appealing user interfaces are desirable. Thus, designing user experience is a common practice in software development. Such a design can specify characteristics of various objects of a user interface with the goal that the design be implemented in the resulting product or service. Such characteristics can include visual appearance and functionality of those objects,

### DRAWINGS

FIG. 1 depicts an environment in which various embodiments may be implemented.

FIG. 2 depicts a system according to an example

FIG. 3 is a block diagram depicting a memory resource and a processing resource according to an example.

FIG. 4 is a flow diagram depicting steps taken to implement an example.

FIGS. 5-6 depict screen views of user interfaces presenting conversation updates according to various examples.

### DETAILED DESCRIPTION

INTRODUCTION: Designing a user experience can be a key factor in developing a commercially successful software product or service. The design process can include generating user interface mockups often referred to as wireframes that define desired visual and functional characteristics of the user interface. The design is then handed off to a development team whose implementation that may or may not conserve all the desired characteristics of the user experience design. For example, developers may deviate from the design by using different user interface controls, layouts, colors, sizes, proportions, or flow. Some deviations may be minor and due to technical limitations, some may be acceptable under the design, but many result from miscommunication or simple oversight on the developer's side. Often, these deviations are discovered during manual acceptance testing by the designers or stakeholders, and sometimes not even then, due to the difficulty of visually comparing the mockup with actual implementation to identify, for example, a missing icon.

Various embodiments, described in detail below, function to generate a conformance rule set from mockup data of a user experience design. The rule set may be generated by electronically parsing mockup data provided by a user interface design tool. The rule set is an abstraction of the design and specifies desired user interface characteristics visually depicted or otherwise represented by the mockup data. Such characteristics can be visual such as color, size, and position of user interface objects. Desired characteristics can be functional such as a desired result of an interaction with a given user interface object. The rule set can then be associated with a particular application or user interface for later access when testing the conformance of that user interface with the user experience design.

To test conformance, screen capture data for a user interface generated by an application under test is accessed. The screen capture data, may for example by provided by an application testing tool. The screen capture data is processed or otherwise analyzed to identify actual characteristics of the user interface. The conformance rule set can then be processed to identify and report differences between the desired characteristics and the actual characteristics. Such differences may be minor and deserve a warning. Other differences may warrant an error indicating a test failure.

The following description is broken into sections. The first, labeled “Environment,” describes an environment in which various embodiments may be implemented. The second section, labeled “Components,” describes examples of various physical and logical components for implementing various embodiments. The third section, labeled as “Operation,” describes steps taken to implement various embodiments.

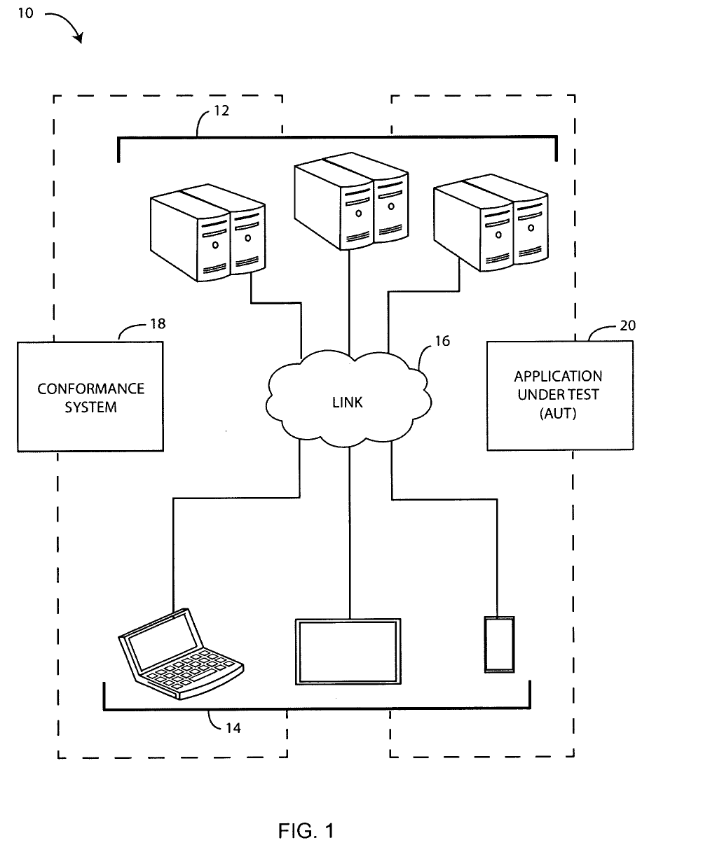

ENVIRONMENT: FIG. 1 depicts an environment 10 in which various embodiments may be implemented. Environment 10 is shown to include server devices 12 and client devices 4 interconnected by link 16. Server devices 12 represent any computing devices capable of serving applications having user interfaces that may be displayed client devices 14. Client devices 14 represent generally any computing devices capable of accessing applications served by server devices 12.

Link 16 represents generally one or more of a cable, wireless, fiber optic, or remote connections via a telecommunication link, an infrared link, a radio frequency link, or any other connectors or systems that provide electronic communication. Link 16 may include, at least in part, an intranet, the Internet, or a combination of both. Link 16 may also include intermediate proxies, routers, switches, load balancers, and the like.

FIG. 1 also depicts conformance system 18 and application under test (AUT) 20. Described in more detail below, conformance system 18 represents a computing device or combination of computing devices configured to test the conformance of a user interface of AUT 20. In particular system 18 is responsible for generating a conformance rule set from mockup data of a user experience design for AUT 20. The conformance rule set specifies desired user interface characteristics. System 18 analyzes screen capture data taken AUT 20 to identify actual characteristics of the user interface. System 18 then processes the conformance rule set to identify and report differences between the desired characteristics and the actual characteristics. System 18 may be implemented using server devices 12, client devices 14 or a combination of the two. AUT 20 may be an application executing on server services 12, client devices 14, or a combination of the two.

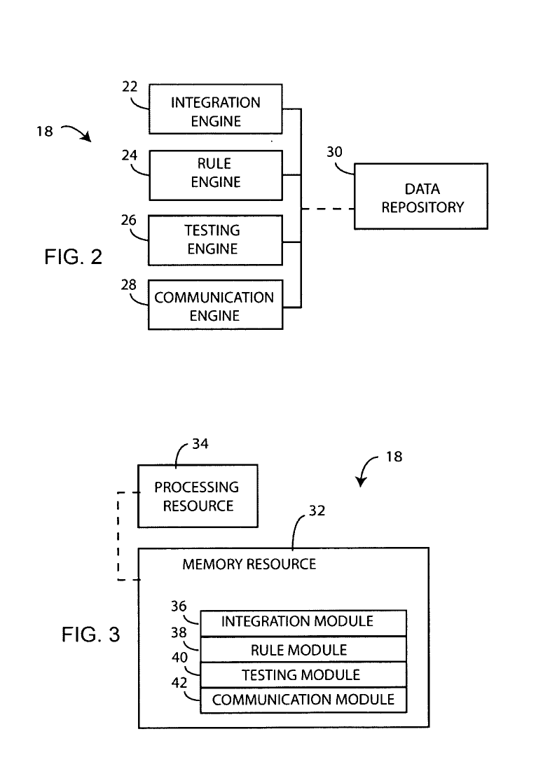

COMPONENTS: FIGS. 2 and 3 depict examples of physical and logical components for implementing various embodiments. In FIG. 2 various components are identified as engines 22-28. In describing engines 22-28, focus will be on each engine's designated function. However, the term engine, as used herein, refers to a combination of hardware and programming configured to perform a designated function. As is illustrated later with respect to FIG. 3, the hardware of each engine, for example, may include a processor and a memory, while the programing is code stored on that memory and executable by the processor to perform the designated function.

FIG. 2 depicts conformance system 18 for testing conformance of a user interface with a user experience design. System 18 is shown to include integration engine 22, rule engine 24, testing engine 26, and communication engine 28. Integration engine 22 is configured to access mockup data from an external application. The accessed mockup data is electronic data that that defines a visual representation of desired characteristics of a user interface. The external application may be an application configured to generate mockup representations, often referred to as wire frames, of a user interface. The mockup representations may include data designed to be processed to display a visual representation of the user interface showing desired user interface objects, desired visual characteristics of those objects, and desired responses to interactions with those objects. The mockup representation may also include metadata that further defines desired visual characteristics. Such metadata may include a document object model (DOM). The metadata may include data indicative of a desired response to a user interaction with a specified user interface object such as a desired flows between various screens.

Rule engine 22 is configured to analyze the mockup data to identify the desired characteristics, derive a conformance rule set based on the identified desired characteristics, and associate the conformance rule set with the user interface. The conformance rule set is an abstraction of the mockup data and is configured to be processed for use in generating conformance data indicative of differences between the desired characteristics and actual characteristics of a user interface produced by an application under test. In an example, rule engine 22 may analyze the visual representation provided in the mockup data to identify specific shapes that are correlated to known object types. The inclusion of an object type can be noted as well as characteristics such as size and color. Further, rule engine 22 may note the relative positions between two or more of the identified object types. In other words, rule engine 22 is configured to derive a conformance rule set based on desired user interface characteristics identified through an examination of mockup data for a user interface.

A conformance rule set can include, for example, rules specifying the inclusion of a specified user interface object, rules specifying the visual appearance of a specified user interface object, rules specifying relative visual appearances for a plurality of user interface objects as well as rules specifying a desired result of a specified interaction with a specified user interface object. Rule engine 22 may associate the conformance rule set with the user interface represented by the mockup data and stored in data repository 30. The association allows for later retrieval of the conformance rule set when testing conformance of the user interface as produced by an application under test.

Integration engine 22 may also be configured to access a screen capture data set for a user interface as produced by an application under test: A screen capture data set is electronic data that includes a visual image of the user interface, a series of visual images of the user interface, or a video of the user interface. Each visual image represents the user interface in a given state. A video may represent the user interface transitioning between states. Testing engine 26 is configured to analyze the screen capture data set to identify actual characteristics of the user interface and execute the conformance rule set against the identified actual characteristics to generate conformance data. In an example, testing engine 26 may analyze the visual representation provided in the screen capture data to identify specific shapes that are correlated to known object types. The inclusion of an object type can be noted as well as characteristics such as size and color. Further, testing engine 26 may note the relative positions between two or more of the identified object types. Testing engine 26 may also note a result of an interaction with an object. All Such notations represent examples of actual characteristics.

Communication engine 28 is configured to report the conformance data generated by test engine 26. As noted, conformance data is electronic data indicative of differences between desired characteristics of the user interface and actual characteristics observed from the screen capture data set. The conformance data can include a conformance indicator for each of the plurality of rules. A conformance indicator is data indicative of a level of conformance with a particular rule. For example, a rule may specify that a particular object is to be included. That rule is either fully complied with or not based on whether or not the object is included in the screen capture data. Another rule might specify a size and color of an object and a tolerance. That rule may be partially complied with if the size and color depicted in the screen capture data no not match the size and color specified by the rule but are within the tolerance.

Communication engine 28 may be configured to prioritize the conformance indicators based on relevance levels to the screen capture data. Thus a conformance indicator that indicates nonconformance may be prioritized of conformance indicator indicative of partial or substantial conformance or vice versa. Moreover rule might specify a desired result of an interaction with an object. If the screen capture data depicts an interaction with that object, a corresponding conformance indicator may be prioritized over another conformance indicator unrelated to an interaction with an object.

Communication engine 28 may report conformance data in a number of fashions. Conformance data may be included in electronic data communicated to an external testing application. Conformance data may be reported in a user interface or electronic message that includes text describing differences between the desired and actual characteristics. The report may also include a marked up version of the screen shot data that visually highlights the differences.

In foregoing discussion, various components were described as combinations of hardware and programming. Such components may be implemented in a number of fashions. Looking at FIG. 3, the programming may be processor executable instructions stored on tangible memory resource 32 and the hardware may include processing resource 34 for executing those instructions. Thus memory resource 32 can be said to store program instructions that when executed by processing resource 34 implement system 18 of FIG. 2.

Memory resource 32 represents generally any number of memory components capable of storing instructions that can be executed by processing resource 34. Memory resource 32 is non-transitory in the sense that it does not encompass a transitory signal but instead is made up of more or more memory components configured to store the relevant instructions. Memory resource 68 may be implemented in a single device or distributed across devices. Likewise processing resource 34 represents any number of processors capable of executing instructions stored by memory resource 32. Processing resource 34 may be integrated in a single device or distributed across devices. Further, memory resource 32 may be fully or partially integrated in the same device as processing resource 34, or it may be separate but accessible to that device and processing resource 34.

In one example, the program instructions can be part of an installation package that when installed can be executed by processing resource 34 to implement system 18. In this case, memory resource 32 may be a portable medium such as a CD, DVD, or flash drive or a memory maintained by a server from which the installation package can be downloaded and installed. In another example, the program instructions may be part of an application or applications already installed. Here, memory resource 32 can include integrated memory such as a hard drive, solid state drive, or the like.

In FIG. 3, the executable program instructions stored in memory resource 32 are depicted as integration module 36, rule module 38, testing module 40, and communication module 42. Integration module 36 represents program instructions that when executed cause processing resource 34 to implement integration engine 22 of FIG. 2. Rule module 38 represents program instructions that when executed cause the implementation of rule engine 24. Likewise, testing module 26 and communication module 28 represents program instructions that when executed implement testing engine 26 and communication engine 28.

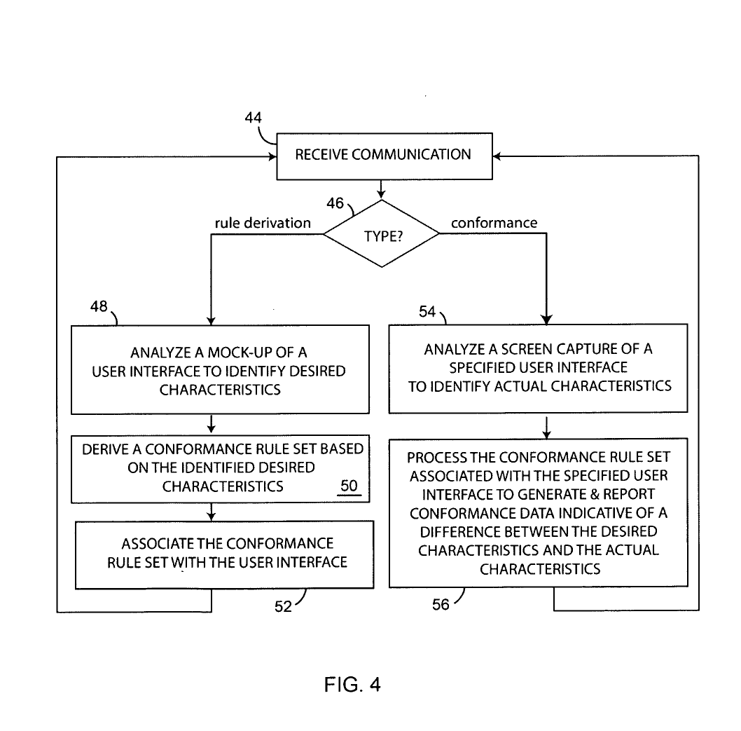

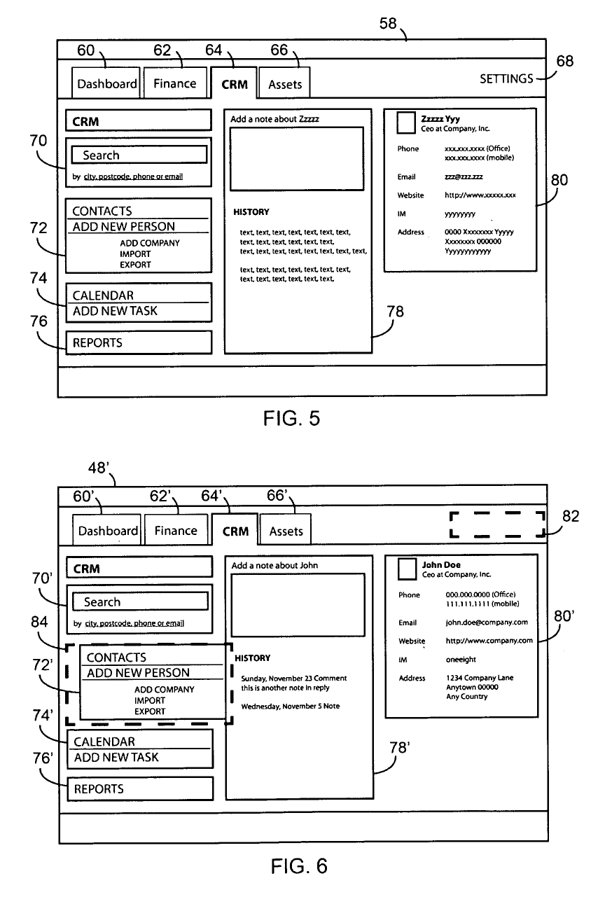

OPERATION: FIG. 4 is a flow diagram of steps taken to implement a user interface conformance method. FIG. 5 depicts a screen view of mockup data, and FIG. 5 depicts a screen capture data. In discussing FIGS. 4-6, reference may be made to components depicted in FIGS. 1-3. Such reference is made to provide contextual examples only and not to limit the manner in which the method depicted by FIG. 4 may be implemented.

Initially in FIG. 4, a request us received (step 44). Referring to FIGS. 1 and 2, the request may be received by integration engine 22. The nature of the request is determined (step 46). If the request is to generate a conformance rule set based on a mockup data, the mockup data is analyzed to identify desired characteristics of the user interface (step 48). A conformance rule set is derived based on the desired characteristics (step 50). The conformance rule set is associated with the user interface (step 52). Referring to FIG. 2, rule engine 24 may be responsible for implementing steps 48-52.

Analyzing in step 48 can include analyzing a mockup that includes a visual representation of the specified user interface and metadata to identify the desired characteristic. Moreover, deriving in step 50 can include deriving a conformance rule set that includes rules specifying the inclusion of a specified user interface object, rules specifying the visual appearance of a specified user interface object, rules specifying relative visual appearances for a plurality of user interface objects, and rules specifying a desired result of a specified interaction with a specified user interface object.

If in step 46, the communication is verify conformance of a user interface with a user experience design, a conformance rule set for a specified user interface is accessed. The conformance rule set includes rules indicative of a desired characteristic of the specified user interface. A screen capture of the user interface is analyzed to identify actual characteristics (step 54). The conformance rule set is processed to generate and report conformance data indicative of a difference between those desired characteristics and the actual characteristics (step 56). Referring to FIG. 2, testing engine 26 and communication engine 28 may be responsible for step 56.

In an example, the conformance rule set may include a first rule specifying a first desired characteristic and a second rule specifying a second desired characteristic. The conformance data generated in step 56 can be indicative of a first conformance indicator corresponding to the first rule and a second conformance indicator corresponding to the second rule. Reporting in step 56 can then include reporting the conformance data such that the first conformance indicator is prioritized over the second conformance indicator if the first desired characteristic includes a desired result of an interaction with an object of the user interface and the second visual characteristic does not.

As an example, FIG. 5 depicts a screen view 58 of a mockup that may be analyzed in step 48. The mockup includes a series of tabs 64-66 with tab 64 selected. Also includes are settings control 68 and frames 70-80 each having a discernable size and position. Analyzing the mockup data, the following partial conformance rule set may be derived in steps 48 and 50:
A tabs frame should be at the top with the following labels: Dashboard, Finance, CRM, Assets. The frame should have a dark background (70% dark).
A control labeled SETTINGS should be on the top right, aligned to the right (10% margin).
A frame 70 should be aligned to the left (5% margin) with a text edit box labeled Search and a link underneath. Frame 70 should be above frame 72. Frame 70 should be to the left of and not touching frame 78. Frame 70 link font should be 50% smaller than the edit box font.
Frame 72 should have a label CONTACTS. Frame 72 should have 150 pixels width and 10 pixels height (height/width ratio 1:15). Frame 72 should be below frame 70 and to the left of and not touching frame 78.

FIG. 6 depicts a screen capture of the interface. Analyzing the screen capture and processing the conformance rule set in steps 54 and 56 a number of differences can be identified between the desired characteristic and the actual characteristic. First, the desired control 68 is missing as highlighted by marking 82. Second frame 72′ is not positioned as desired as it is touching frame 78′ as highlighted by marking 84.

CONCLUSION: FIGS. 1-3 aid in depicting the architecture, functionality, and operation of various embodiments. In particular, FIGS. 2 and 3 depict various physical and logical components. Various components are defined at least in part as programs or programming. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Embodiments can be realized in any memory resource for use by or in connection with processing resource. A “processing resource” is an instruction execution system such as a computer/processor based system or an ASIC (Application Specific Integrated Circuit) or other system that can fetch or obtain instructions and data from computer-readable media and execute the instructions contained therein. A “memory resource” is any non-transitory storage media that can contain, store, or maintain programs and data for use by or in connection with the instruction execution system. The term “non-transitory is used only to clarify that the term media, as used herein, does not encompass a signal. Thus, the memory resource can comprise any one of many physical media such as, for example, electronic, magnetic, optical, electromagnetic, or semiconductor media. More specific examples of suitable computer-readable media include, but are not limited to, hard drives, solid state drives, random access memory (RAM), read-only memory (ROM), erasable programmable read-only memory, flash drives, and portable compact discs.

Although the flow diagram of FIG. 4 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A system comprising a memory resource storing instructions that when executed cause a processing resource to:
derive a conformance rule set based on desired user interface characteristics identified through an examination of mockup data for a user interface, the mockup data including a visual representation of the of the desired characteristics;
generate conformance data based on differences between the desired characteristics and actual characteristics, the differences identified by processing the conformance rule set against screen capture data of the user interface as produced by an application under test, the screen capture data including a visual representation of the actual characteristics of the user interface; and
report the conformance data.

2. The system of claim 1, wherein:
the mock up data includes the visual representation of the desired characteristics and metadata that further specifies the desired characteristics; and
the memory resource stores instructions that when executed cause the processing resource to analyze the mockup data to identify the desired characteristics.

3. The system of claim 1, wherein the conformance rule set includes at least one of:
a rule specifying the inclusion of a specified user interface object;
a rule specifying the visual appearance of a specified user interface object;
a rule specifying relative visual appearances for a plurality of user interface objects; and
a rule specifying a desired result of a specified interaction with a specified user interface object.

4. The system of claim 1, wherein
the screen capture data includes at least one of a visual image of the user interface, a series of visual images of the user interface, and a video of the user interface; and
the memory resource stores instructions that when executed cause the processing resource to analyze the screen capture data to identify the actual characteristics.

5. The system of claim 4, wherein:
the conformance rule set includes a plurality of rules having varying levels of relevance to the screen capture data;
the conformance data includes a conformance indicator for each of the plurality of rules;
the medium incudes instructions that when executed prioritizes the conformance indicators based on relevance levels to the screen capture data.

6. A user interface conformance system, comprising an integration engine and a rule engine, wherein;
the integration engine is configured to access mockup data from an external application, the mockup data including a visual representation of desired characteristics of a user interface; and
the rule engine is configured to analyze the mockup data to identify the desired characteristics, derive a conformance rule set based on the identified desired characteristics, and associate the conformance rule set with the user interface;
wherein the conformance rule set is an abstraction of the mockup data and configured to be processed for use in generating conformance data indicative of differences between the desired characteristics and actual characteristics of a user interface produced by an application under test.

7. The system of claim 6, wherein the mockup data includes meta data further specifying desired characteristics of the user interface, wherein the metadata incudes at least one of a document object model and data indicative of a response to a user interaction with a specified user interface object.

8. The system of claim 6, wherein the rule engine is configured to derive a conformance rule set that includes at least one of:
a rule specifying the inclusion of a specified user interface object;
a rule specifying the visual appearance of a specified user interface object;
a rule specifying relative visual appearances for a plurality of user interface objects; and
a rule specifying a desired result of a specified interaction with a specified user interface object.

9. The system of claim 6, comprising a testing engine and a communication engine, wherein:
the integration engine is configured to access a screen capture data set for the user interface as produced by an application under test;
the testing engine configured to analyze the screen capture data set to identify actual characteristics of the user interface and execute the conformance rule set against the identified actual characteristics to generate conformance data;
the communication engine is configured to report the conformance data.

10. The system of claim 9, wherein:
the screen capture data set is one of a plurality of screen capture data sets each produced for a different step of a script used by the external entity to control the application under test;
the integration engine is configured to access each of the plurality of screen capture data sets in response to a corresponding communication from the external entity; and
for each accessed screen capturer data set, the testing engine is configured to analyze the screen capture data set to identify actual characteristics of the user interface and execute the conformance rule set against the identified actual characteristics to generate conformance data indicative of differences between the desired characteristics and the actual characteristics.

11. A user interface conformance method, comprising:
accessing a conformance rule set for a specified user interface, the conformance rule set including a rule indicative of a desired characteristic of the specified user interface;
analyzing a screen capture of the specified user interface to identify an actual characteristic;
processing the conformance rule set to produce conformance data indicative of a difference between the desired characteristic and the actual characteristic; and
reporting the conformance data.

12. The method of claim 11, wherein:
the conformance rule set includes a first rule specifying a first desired characteristic and a second rule specifying a second desired characteristic;
the conformance data is indicative of a first conformance indicator corresponding to the first rule and a second conformance indicator corresponding to the second rule; and
reporting comprises reporting the conformance data such that the first conformance indicator is prioritized over the second conformance indicator if the first desired characteristic includes a desired result of an interaction with an object of the specified user interface and the second visual characteristic does not.

13. The method of claim 11, comprising:
analyzing a mockup of the specified user interface to identify the desired characteristic;
deriving the conformance rule set according to the identified desired characteristic; and
associating the conformance rule set with the specified user interface.

14. The method of claim 13, wherein deriving comprises deriving a conformance rule set that includes at least one of:
a rule specifying the inclusion of a specified user interface object;
a rule specifying the visual appearance of a specified user interface object;
a rule specifying relative visual appearances for a plurality of user interface objects; and
a rule specifying a desired result of a specified interaction with a specified user interface object.

15. The method of claim 13 wherein analyzing comprises analyzing a mockup that includes a visual representation of the specified user interface and metadata to identify the desired characteristic.
